(19) United States
(12) Patent Application Publication
(10) Pub. No.: US 2020/0222982 A1
(43) Pub. Date: Jul. 16, 2020

(54) Apparatus for Additive Manufacturing

(71) Applicant: Hitachi, Ltd., Tokyo (JP)

(72) Inventor: Kinya AOTA, Tokyo (JP)

(21) Appl. No.: 16/614,502

(22) PCT Filed: Mar. 23, 2018
(86) PCT No.: PCT/JP2018/011606

§ 371 Date: Nov. 18, 2019

(30) Foreign Application Priority Data
Jun. 8, 2017 (JP) 2017-113714

(51) Int. Cl. B22F 3/105; B33Y 30/00

(52) U.S. Cl. CPC B22F 3/1055; B22F 2003/1056; B33Y 30/00

(57) ABSTRACT

There is provided an additive manufacturing apparatus that can effectively removing fume even in a vacuum state. An additive manufacturing apparatus 1 includes a fume capturing mechanism 8 that is provided to be movable in a space R defined between a beam source 9 and a stage 51, and that captures fume F generated due to melting of a powder P.

### TECHNICAL FIELD

The present invention relates to an additive manufacturing apparatus.

### BACKGROUND ART

In the related art, additive manufacturing techniques are known. Additive manufacturing is a process of making an object based on a numerical representation of a three-dimensional shape by adhering a material, and is in contrast to the subtractive manufacturing. Additive manufacturing is also referred to as “3D printer” or “lamination molding”, and is often implemented by laminating a plurality of layers.

As an example of an apparatus that performs additive manufacturing, there is an apparatus that manufactures a three-dimensional shaped molded object in which a plurality of solidified layers are laminated and integrated by repeatedly performing formation of the solidified layers by irradiating a predetermined portion of a powder layer with a light beam (see PTL 1 below). A related-art apparatus described in Patent Literature 1 includes a powder layer formation unit, a light beam irradiation unit, a molding table, a chamber, a light transmission window, and a gas flow formation unit (see claim 13 and the like of PTL 1).

The powder layer formation unit forms a powder layer. The light beam irradiation unit irradiates the powder layer with a light beam such that a solidified layer is formed. On the molding table, the powder layer and the solidified layer are formed. The chamber includes the powder layer formation unit and the molding table in an inner portion thereof. The light transmission window is provided in the chamber to allow the light beam emitted from the light beam irradiation unit to enter the chamber. The gas flow formation unit forms a local gas flow in the chamber, and includes a supply nozzle and a suction nozzle.

With the configuration described above, fume generated due to the irradiation of the light beam can be effectively trapped in the chamber. That is, the generated fume can be guided and retained in a local region within the chamber, and eventually be removed from the chamber. Accordingly, fogging of the light transmission window in the chamber can be prevented, and blocking to a light beam path due to the fume can also be prevented (see paragraph [0020] and the like of PTL 1).

### PRIOR ART LITERATURE

### Patent Literature

PTL 1: WO2011/049143

### SUMMARY OF INVENTION

### Technical Problem

The related-art apparatus forms a local gas flow by making gas locally flow in the chamber so as to remove fume. However, when the chamber is in a vacuum state in which a pressure thereof is lower than an atmospheric pressure, it is difficult to form a local gas flow, which makes it difficult to remove the fume.

Therefore, the invention provides an additive manufacturing apparatus capable of effectively removing the fume even in a vacuum state.

### Solution to Problem

An additive manufacturing apparatus according to the invention includes a stage on which a powder of an additive manufacturing material is placed and a beam source configured to irradiate the powder with a high energy beam, and is configured to manufacture a molded object by melting and bonding the powder with the high energy beam, and the additive manufacturing apparatus further includes a fume capturing mechanism provided to be movable in a space defined between the beam source and the stage, and configured to capture fume generated due to melting of the powder.

### Advantageous Effect

According to the invention, an additive manufacturing apparatus capable of effectively removing fume even in a vacuum state with a fume capturing mechanism can be provided. Problems, configurations, and effects other than those described above will be clarified with the following embodiments.

### BRIEF DESCRIPTION OF DRAWINGS

FIG. 1 is a schematic cross-sectional view of an additive manufacturing apparatus according to a first embodiment of the invention.

FIG. 2 is a schematic cross-sectional view of the additive manufacturing apparatus, which illustrates an operation of a fume capturing mechanism shown in FIG. 1.

FIG. 3 is a schematic cross-sectional view of an additive manufacturing apparatus according to a second embodiment of the invention.

FIG. 4 is a schematic cross-sectional view of an additive manufacturing apparatus according to a third embodiment of the invention.

FIG. 5 is a schematic cross-sectional view of an additive manufacturing apparatus according to a fourth embodiment of the invention.

FIG. 6 is a schematic cross-sectional view of an additive manufacturing apparatus according to a fifth embodiment of the invention.

FIG. 7 is a schematic cross-sectional view of an additive manufacturing apparatus according to a sixth embodiment of the invention.

### DESCRIPTION OF EMBODIMENTS

Hereinafter, embodiments of an additive manufacturing apparatus according to the invention will be described with reference to the drawings.

### First Embodiment

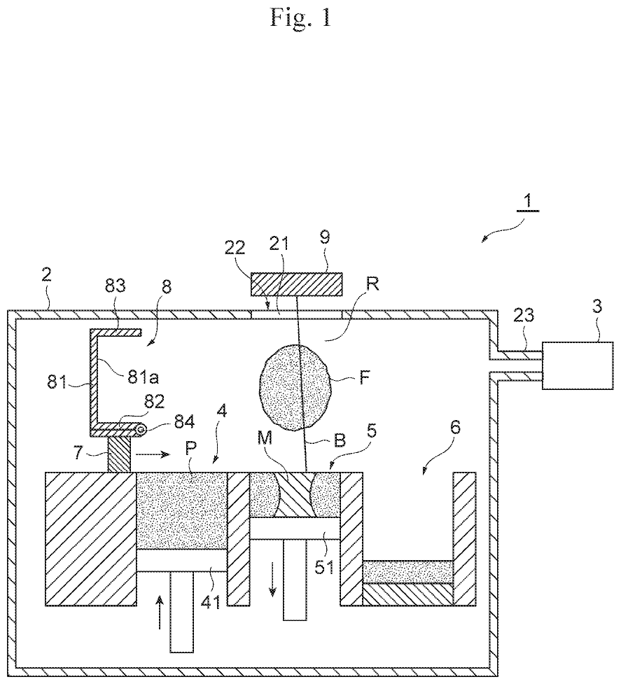

FIG. 1 is a schematic cross-sectional view showing a schematic configuration of an additive manufacturing apparatus 1 according to a first embodiment of the invention. The additive manufacturing apparatus 1 of the present embodiment is, for example, an additive manufacturing apparatus of a powder bed melting and bonding type which manufactures a molded object M by melting and bonding a powder P of an additive manufacturing material with a high energy beam B such as a laser beam or an electron beam.

The additive manufacturing apparatus 1 of the present embodiment includes a fume capturing mechanism 8 that is provided to be movable in a space R defined between a stage 51 on which the powder P is placed and a beam source 9 that irradiates the powder P with the high energy beam B, and that captures fume F generated due to melting of the powder P. Hereinafter, the additive manufacturing apparatus 1 of the present embodiment will be described in detail.

The additive manufacturing apparatus 1 of the present embodiment includes, for example, a chamber 2, a decompression unit 3, a material supply part 4, an additive manufacturing unit 5, a collection part 6, a recoater 7, the fume capturing mechanism 8, and the beam source 9. The material supply part 4 includes a stage 41 for supplying the powder P of the additive manufacturing material, and the additive manufacturing unit 5 includes the stage 51 for additive manufacturing.

The chamber 2 accommodates, for example, components of the additive manufacturing apparatus 1 excluding the beam source 9 and the decompression unit 3. The chamber 2 includes, for example, a transmission window 22 in which a protective glass 21 is fitted. The high energy beam B emitted from the beam source 9 disposed at an outer portion of the chamber 2 transmits through the transmission window 22, to reach the powder P of the additive manufacturing material placed on the stage 51 of the additive manufacturing unit 5 in an inner portion of the chamber 2.

The decompression unit 3 is configured with, for example, a vacuum pump, and is connected to a pipe for vacuum evacuation 23 provided in the chamber 2. The decompression unit 3 discharges the air in the chamber 2 through, for example, the pipe for vacuum evacuation 23, thereby bringing an internal pressure of the chamber 2 to a vacuum pressure lower than an atmospheric pressure to bring the chamber 2 into a vacuum state.

The material supply part 4 is, for example, a concave portion surrounded by side walls and a bottom wall. The bottom wall of the material supply part 4 is configured with the stage 41 for material supply. The material supply part 4 is open on an upper side and has an opening part at an upper end of the side walls. The powder P of the additive manufacturing material is placed on the stage 41 for material supply. The stage 41 for material supply is provided to be capable of being lifted and lowered at a predetermined pitch by an appropriate elevating mechanism.

The additive manufacturing material used for additive manufacturing the molded object M is not particularly limited. For example, a powder of a metal material such as copper, a titanium alloy, a nickel alloy, an aluminum alloy, a cobalt chromium alloy, or stainless steel, a powder of a resin material such as polyamide, and a ceramic powder can be used.

Similar to the material supply part 4 described above, the additive manufacturing unit 5 is, for example, a concave portion surrounded by side walls and a bottom wall. The bottom wall of the additive manufacturing unit 5 is configured with the stage 51 for additive manufacturing. Similar to the material supply part 4, the additive manufacturing unit 5 is open on an upper side and has an opening part at an upper end of the side walls. The powder P of the additive manufacturing material supplied from the material supply part 4, and the molded object M manufactured by additive manufacturing are placed on the stage 51 for additive manufacturing. The opening part of the additive manufacturing unit 5 and the opening part of the material supply part 4 are, for example, substantially equal in height in a vertical direction, and are arranged substantially in a horizontal direction. Similar to the stage 41 for material supply, the stage 51 for additive manufacturing, for example, is provided to be capable of being lifted and lowered at a predetermined pitch by an appropriate elevating mechanism.

The collection part 6 is, for example, a concave portion surrounded by side walls and a bottom wall. The bottom wall of the collection part 6 is fixed to lower end portions of the side walls in the illustrated example, and alternatively may be configured with a stage capable of being lifted and lowered similarly to the material supply part 4 and the additive manufacturing unit 5. The collection part 6 is open on an upper side and has an opening part at an upper end of the side walls. The opening part of the collection part 6 and the opening part of the additive manufacturing unit 5 are substantially equal in height in the vertical direction, and are arranged substantially in the horizontal direction. The collection part 6, for example, accommodates and collects excess powder P supplied from the material supply part 4 to the additive manufacturing unit 5 with the recoater 7, and collects particles derived from the fume F captured by the fume capturing mechanism 8.

The recoater 7, for example, is provided to be capable of being moved, by an appropriate moving mechanism, in a substantially horizontal direction along the opening parts of the material supply part 4 and the additive manufacturing unit 5. The recoater 7 is provided to be capable of being reciprocally moved in a moving direction thereof. When the powder P of the additive manufacturing material is supplied from the material supply part 4 to the additive manufacturing unit 5, the recoater 7 is moved from a position behind the opening part of the material supply part 4 to a position facing the opening part of the collection part 6, crossing the opening part of the material supply part 4 and the opening part of the additive manufacturing unit 5.

The beam source 9 may be, for example, an electron beam source that generates an electron beam having an output of about several kW in vacuum, or a laser light source that generates a laser having an output of about several hundred W to several kW. The beam source 9 of the additive manufacturing apparatus 1 of the present embodiment is, for example, a laser light source that generates a single-mode fiber laser having a wavelength of 1080 nm and an output of 500 W, that is, a fiber laser having an energy intensity in Gaussian distribution. It should be noted that when the beam source 9 is an electron beam source, the beam source 9 may be disposed in the chamber 2.

The fume capturing mechanism 8 is provided to be capable of moving in the space R defined between the beam source 9 and the stage 51 for additive manufacturing, and is configured to capture the fume F generated due to melting of the powder P placed on the stage 51 for additive manufacturing. The fume capturing mechanism 8 includes, for example, a capturing part 81 that extends in a direction intersecting the moving direction in the space R defined between the beam source 9 and the stage 51 for additive manufacturing to adhere the fume F thereto.

In the example illustrated in FIG. 1, the capturing part 81 extends in the vertical direction orthogonal to the horizontal direction that is the moving direction of the fume capturing mechanism 8. It should be noted that the capturing part 81 may be inclined at a predetermined angle with respect to the vertical direction. In the example illustrated in FIG. 1, the capturing part 81 is formed in a plate shape having a capturing surface 81a intersecting the moving direction of the fume capturing mechanism 8. More specifically, the capturing part 81, for example, is formed in a plate shape having a capturing surface 81a perpendicular to the horizontal direction that is the moving direction of the fume capturing mechanism 8.

In the example illustrated in FIG. 1, the fume capturing mechanism 8 includes a receiving part 82 that extends in a direction intersecting an extending direction of the capturing part 81 and that receives particles derived from the fume F separated from the capturing part 81. More specifically, the receiving part 82 extends from a lower end of the capturing part 81 and in a horizontal direction orthogonal to the vertical direction that is the extending direction of the capturing part 81. The receiving part 82 catches the particles derived from the fume F which is dropped after being separated from the capturing part 81, on an upper surface thereof.

In the example illustrated in FIG. 1, the fume capturing mechanism 8 includes an upper wall part 83 that extends in the direction intersecting the extending direction of the capturing part 81 and prevents the fume F from moving in the extending direction of the capturing part 81. More specifically, the upper wall part 83 extends from an upper end of the capturing part 81 in the horizontal direction orthogonal to the vertical direction that is the extending direction of the capturing part 81. The upper wall part 83 blocks movement of the fume F in the vertical direction that is the extending direction of the capturing part 81, and prevents the fume F, which is present in a front side in a moving direction of the capturing part 81, from moving toward an upper side in the vertical direction when the fume capturing mechanism 8 moves. In order to make the receiving part 82 catch the particles, which are derived from the fume F adhered to a lower surface of the upper wall part 83, when the particles drop, it is preferable that the entire upper wall part 83 is positioned on an upper side of the receiving part 82 in the vertical direction.

In the example illustrated in FIG. 1, the fume capturing mechanism 8 is fixed to an upper end portion of the recoater 7. Since the fume capturing mechanism 8 moves in the moving direction of the recoater 7 accompanying the movement of the recoater 7, the fume capturing mechanism 8 substantially crosses the space R, defined between the beam source 9 and the stage 51 for additive manufacturing which are disposed vertically, in the horizontal direction.

It should be noted that the fume capturing mechanism 8 is not limited to a configuration in which the fume capturing mechanism 8 is fixed to the recoater 7. That is, the additive manufacturing apparatus 1 may include a moving mechanism that moves the fume capturing mechanism 8 in the moving direction separately from the moving mechanism of the recoater 7. The moving direction of the fume capturing mechanism 8 is not limited to a lateral direction along the horizontal direction, and may be an upper-lower direction along the vertical direction, or a direction inclined at a predetermined angle with respect to the horizontal direction and the vertical direction.

In the example illustrated in FIG. 1, the fume capturing mechanism 8 includes a rotation mechanism 84 that rotates the capturing part 81 toward the collection part 6. The rotation mechanism 84 can be configured with, for example, a hinge that rotates about a rotation axis that is orthogonal to the moving direction of the fume capturing mechanism 8 and the vertical direction. The rotation mechanism 84 includes, for example, a plate shaped base part fixed to an upper surface of the recoater 7, and a hinge provided at one end of the base part. The capturing part 81 is fixed to the hinge of the rotation mechanism 84 via, for example, the receiving part 82.

Hereinafter, functions of the additive manufacturing apparatus 1 of the present embodiment will be described.

In order to perform additive manufacturing of the molded object M with the additive manufacturing apparatus 1 of the present embodiment, first, the inner portion of the chamber 2 is decompressed to the vacuum state in which a pressure thereof is lower than the atmospheric pressure. Here, as described above, the additive manufacturing apparatus 1 of the present embodiment includes the chamber 2 that accommodates the stage 51 of the additive manufacturing unit 5 and the fume capturing mechanism 8, and the decompression unit 3 that decompresses the inner portion of the chamber 2 to the vacuum state in which the pressure thereof is lower than the atmospheric pressure. Accordingly, with the decompression unit 3, air in the chamber 2 can be discharged, and the chamber 2 can be decompressed to the vacuum state in which the pressure thereof is lower than the atmospheric pressure.

Next, the stage 51 of the additive manufacturing unit 5 is lowered at a predetermined pitch from the opening part at the upper end of the side walls, so that the additive manufacturing unit 5 is in a state of being capable of accommodating a predetermined amount of powder P of the additive manufacturing material. Next, the stage 41 of the material supply part 4 is lifted at a predetermined pitch to push up the predetermined amount of powder P of the additive manufacturing material, to an upper side of the opening part. Next, the recoater 7 is moved to cross the opening part of the material supply part 4, so that the powder P pushed up to the upper side of the opening part of the material supply part 4 is moved to the additive manufacturing unit 5 by the recoater 7.

Further, the recoater 7 is moved to cross the opening part of the additive manufacturing unit 5, so that the powder P is introduced by the recoater 7 into the opening part of the additive manufacturing unit 5 to be placed on the stage 51 of the additive manufacturing unit 5, and the powder P is spread evenly by the recoater 7 to a height of the opening part of the additive manufacturing unit 5. At this time, the excess powder P is introduced into the opening part of the collection part 6 by the recoater 7, and is accommodated in the collection part 6 and collected. Thereafter, the recoater 7 is moved in a reverse direction to return to an original position thereof.

Next, based on data of a three-dimensional shape of the molded object M, a predetermined region of the powder P placed on the stage 51 of the additive manufacturing unit 5 is irradiated with a high energy beam B such as a laser beam or an electron beam from the beam source 9. Accordingly, the powder P in the predetermined region is melted and bonded to form a portion of the molded object M. At this time, the fume F is generated accompanying the melting of the powder P. The fume F is suspended in the space R defined between the beam source 9 and the stage 51 of the additive manufacturing unit 5.

Next, the stage 51 of the additive manufacturing unit 5 is lowered at the predetermined pitch, so that the additive manufacturing unit 5 is in a state of being capable of accommodating the predetermined amount of powder P of the additive manufacturing material, over the powder P placed on the stage 51 and over a portion of the molded object M. Next, the stage 41 of the material supply part 4 is lifted at a predetermined pitch to push up the predetermined amount of powder P of the additive manufacturing material, from the opening part to an upper side thereof. Next, the recoater 7 is moved to cross the opening part of the material supply part 4, so that the powder P pushed up to the upper side of the opening part of the material supply part 4 is moved to the additive manufacturing unit 5 by the recoater 7.

Further, the recoater 7 is moved to cross the opening part of the additive manufacturing unit 5 so that new powder P is introduced by the recoater 7 into the opening part of the additive manufacturing unit 5. Further, the new powder P is spread evenly by the recoater 7 to the height of the opening part of the additive manufacturing unit 5, over the powder P placed on the stage 51 of the additive manufacturing unit 5 and over the portion of the molded object M. At this time, the excess powder P supplied from the material supply part 4 to the additive manufacturing unit 5 is introduced into the opening part of the collection part 6 by the recoater 7, and is accommodated in the collection part 6 and collected.

By moving the recoater 7, which functions as a moving mechanism for moving the fume capturing mechanism 8, to cross the opening part of the additive manufacturing unit 5, the fume capturing mechanism 8 is moved in the space R defined between the beam source 9 and the stage 51 of the additive manufacturing unit 5. Accordingly, the fume F generated accompanying the melting of the powder P and suspended in the space R defined between the beam source 9 and the stage 51 of the additive manufacturing unit 5 is captured and removed by the fume capturing mechanism 8. Thereafter, the recoater 7 is moved in the reverse direction to return to the original position thereof. The additive manufacturing of the molded object M is performed by repeating the above procedure.

As described above, the additive manufacturing apparatus 1 of the present embodiment includes the stage 51 on which the powder P of the additive manufacturing material is placed and the beam source 9 that irradiates the powder P with the high energy beam B, and manufactures the molded object M by melting and bonding the powder P with the high energy beam B. Further, as described above, the additive manufacturing apparatus 1 of the present embodiment includes the fume capturing mechanism 8 that is provided to be movable in the space R defined between the beam source 9 and the stage 51, and that captures the fume F generated due to melting of the powder P. With this configuration, the additive manufacturing apparatus 1 of the present embodiment can effectively remove the fume F even in the vacuum state with the fume capturing mechanism 8.

In the additive manufacturing apparatus 1 of the present embodiment, as described above, the fume capturing mechanism 8 includes the capturing part 81 that extends in the direction intersecting the moving direction in the space R defined between the beam source 9 and the stage 51 of the additive manufacturing unit 5 to adhere the fume F thereto. Accordingly, the capturing part 81 can pass through a wide range of the space R in which the fume F is suspended, and more of the fume F can be adhered to the capturing part 81 and captured.

In addition, in the additive manufacturing apparatus 1 of the present embodiment, the fume capturing mechanism 8 includes the receiving part 82 that extends in the direction intersecting the extending direction of the capturing part 81 and that receives the particles derived from the fume F separated from the capturing part 81. Accordingly, the particles derived from the fume F and finer than the powder P of the additive manufacturing material are prevented from being mixed into the powder P of the material supply part 4 and of the additive manufacturing unit 5, flowability of the powder P is prevented from being lowered in the material supply part 4 and the additive manufacturing unit 5, and occurrence of poor spread of the powder P in the additive manufacturing unit 5 is prevented.

In addition, in the additive manufacturing apparatus 1 of the present embodiment, the capturing part 81 is formed in a plate shape having the capturing surface 81a intersecting the moving direction of the fume capturing mechanism 8. Accordingly, the capturing surface 81a can pass over a wide range of the space R in which the fume F is suspended, and more of the fume F can be adhered to the capturing surface 81a and captured.

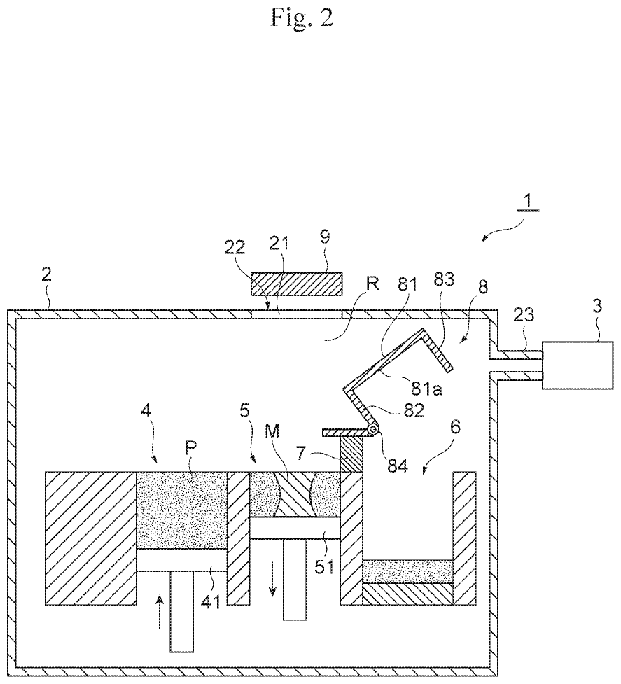

As described above, the additive manufacturing apparatus 1 of the present embodiment includes the collection part 6 that collects the particles derived from the fume F captured by the fume capturing mechanism 8. The fume capturing mechanism 8 includes the rotation mechanism 84 that rotates the capturing part 81 toward the collection part 6. Hereinafter, functions of the rotation mechanism 84 will be described with reference to FIG. 2.

FIG. 2 is a schematic cross-sectional view of the additive manufacturing apparatus 1, which illustrates operations of the rotation mechanism 84 of the fume capture mechanism 8 shown in FIG. 1. For example, after moving in the space R defined between the beam source 9 and the stage 51 of the additive manufacturing unit 5, the fume capturing mechanism 8 rotates the capturing part 81 toward the collection part 6 with the rotation mechanism 84. Accordingly, the particles derived from the fume F captured by the capturing part 81 can be dropped into the collection part 6 and collected. In the example illustrated in FIG. 2, the receiving part 82 is also rotated toward the collection part 6 by the rotation mechanism 84, and particles derived from the fume F accumulated on the receiving part 82 can also be dropped into the collection part 6 and collected.

It should be noted that a timing at which the fume capturing mechanism 8 rotates the capturing part 81 toward the collection part 6 with the rotation mechanism 84 is not particularly limited. The fume capturing mechanism 8 can rotate the capturing part 81 toward the collection part 6 with the rotation mechanism 84, for example, each time the fume capturing mechanism 8 moves in the space R defined between the beam source 9 and the stage 51 of the additive manufacturing unit 5, or when the number of times of movement thereof reaches a predetermined number of times, or when a predetermined time has passed, or when a predetermined amount of the fume F is captured.

As described above, the additive manufacturing apparatus 1 of the present embodiment includes the upper wall part 83 that extends in the direction intersecting the extending direction of the capturing part 81 and that prevents the fume F from moving upward along the extending direction of the capturing part 81. Accordingly, when the fume capturing mechanism 8 is moved, the fume F can be prevented from adhering to the protective glass 21 provided in the transmission window 22 of the chamber 2.

In addition, the additive manufacturing apparatus 1 of the present embodiment includes a moving mechanism that moves the fume capturing mechanism 8 in the moving direction thereof, and accordingly the fume F suspended in the space R defined between the beam source 9 and the stage 51 of the additive manufacturing unit 5 can be captured by moving the fume capturing mechanism 8. It should be noted that, by fixing the fume capturing mechanism 8 to the recoater 7 and using the recoater 7 as a moving mechanism that moves the fume capturing mechanism 8, it is unnecessary to newly install a moving mechanism for moving the fume capturing mechanism 8.

As described above, according to the additive manufacturing apparatus 1 of the present embodiment, the fume F can be effectively removed with the fume capturing mechanism 8 even in the vacuum state. Therefore, absorption of the high energy beam B by the fume F can be prevented, thereby improving the output of the high energy beam B reaching the powder P of the additive manufacturing unit 5, and occurrence of poor molding in the molded object M can be prevented so that a high-quality molded object M can be manufactured.

### Second Embodiment

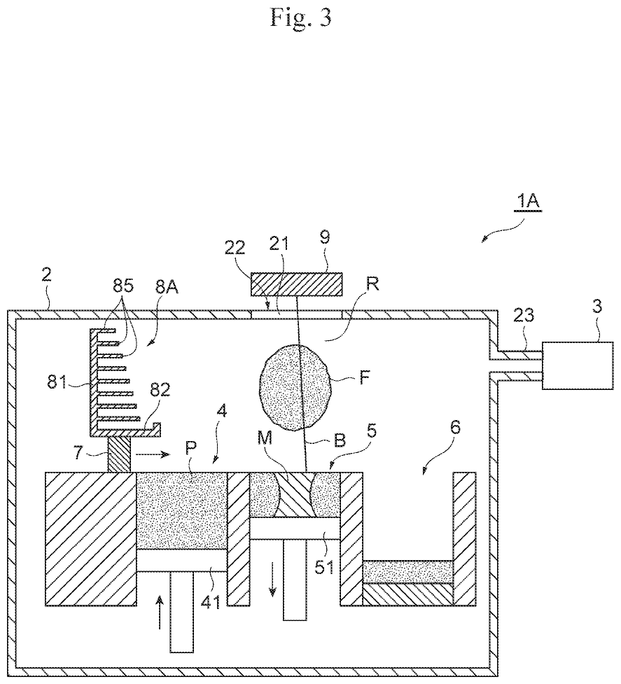

Next, a second embodiment of the additive manufacturing apparatus of the invention will be described with reference to FIG. 3.

FIG. 3 is a schematic cross-sectional view showing a schematic configuration of an additive manufacturing apparatus LA according to the second embodiment of the invention. The additive manufacturing apparatus 1A of the present embodiment is different from the additive manufacturing apparatus 1 according to the first embodiment in a configuration of a fume capturing mechanism 8A. Since other components of the additive manufacturing apparatus 1A of the present embodiment are similar to those of the additive manufacturing apparatus 1 according to the first embodiment, the same components are denoted by the same reference numerals, and description thereof is omitted.

Similarly to the additive manufacturing apparatus 1 of the first embodiment, the additive manufacturing apparatus 1A of the present embodiment includes the fume capturing mechanism 8A that is provided to be movable in the space R defined between the beam source 9 and the stage 51, and that captures the fume F generated due to melting of the powder P. Therefore, similarly to the additive manufacturing apparatus 1 of the first embodiment, the additive manufacturing apparatus 1A of the present embodiment can effectively remove the fume F with the fume capturing mechanism 8A even in a vacuum state, and manufacture a high-quality molded object M.

In addition, in the additive manufacturing apparatus 1A of the present embodiment, the capturing part 81 of the fume capturing mechanism 8A includes a plurality of fins 85 that protrude toward a front side in a moving direction of the fume capturing mechanism 8A which is directed from the material supply part 4 to the additive manufacturing unit 5. Accordingly, in the fume capturing mechanism 8A, the area of a surface to which the fume F is adhered can be increased, and more of the fume F can be captured more reliably. In addition, by adhering and capturing the fume F between the fin 85 and the fin 85, the particles derived from the adhered fume F can be prevented from dropping or suspending after being separated from the fume capturing mechanism 8A.

In addition, the plurality of fins 85 protruding from the capturing part 81, for example, may have different lengths. In this case, for example, fins 85 on a lower side may be longer than fins 85 on an upper side. Accordingly, even when particles derived from the fume F adhered to the fins 85 on the upper side drop, the dropped particles can be caught by the fins 85 on the lower side. In addition, a length of the receiving part 82 in a direction in which the fins 85 protrude can be made larger than the length of all the fins 85. Accordingly, even when particles derived from the fume F adhered to the plurality of fins 85 drop, the dropped particles can be caught by the receiving part 82.

### Third Embodiment

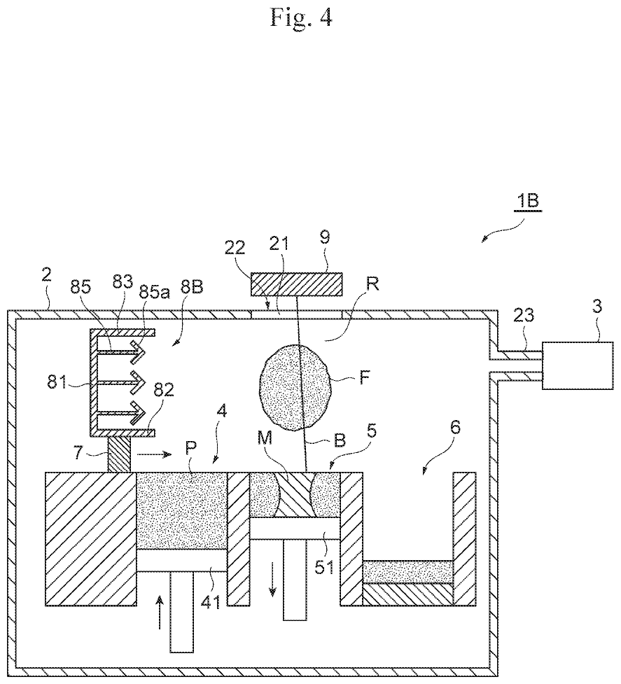

Next, a third embodiment of the additive manufacturing apparatus of the invention will be described with reference to FIG. 4.

FIG. 4 is a schematic cross-sectional view showing a schematic configuration of an additive manufacturing apparatus 1B according to the third embodiment of the invention. The additive manufacturing apparatus 1B of the present embodiment is different from the additive manufacturing apparatus 1 according to the first embodiment in a configuration of the fume capturing mechanism 8B. Since other components of the additive manufacturing apparatus 1B of the present embodiment are similar to those of the additive manufacturing apparatus 1 according to the first embodiment, the same components are denoted by the same reference numerals, and description thereof is omitted.

Similarly to the additive manufacturing apparatus 1 of the first embodiment, the additive manufacturing apparatus 1B of the present embodiment includes the fume capturing mechanism 8B that is provided to be movable in the space R defined between the beam source 9 and the stage 51, and that captures the fume F generated due to melting of the powder P. Therefore, similarly to the additive manufacturing apparatus 1 of the first embodiment, the additive manufacturing apparatus 1B of the present embodiment can effectively remove the fume F with the fume capturing mechanism 8B even in a vacuum state, and manufacture a high-quality molded object M.

In addition, in the additive manufacturing apparatus 1B of the present embodiment, similarly to the additive manufacturing apparatus 1A of the second embodiment, the capturing part 81 of the fume capturing mechanism 8B includes a plurality of fins 85. Further, the fin 85 includes, at a tip end portion on a front side in a moving direction of the fume capturing mechanism 8B which directs from the material supply part 4 to the additive manufacturing unit 5, an inclined part 85a that extends obliquely rearward in the moving direction. In this way, by setting a shape of the fin 85 to be a shape of an arrow, the fume F captured between the fin 85 and the fin 85 can be more reliably prevented from being re-suspended, or the particles derived from the fume F can be more reliably prevented from dropping to the material supply part 4 and the additive manufacturing unit 5.

### Fourth Embodiment

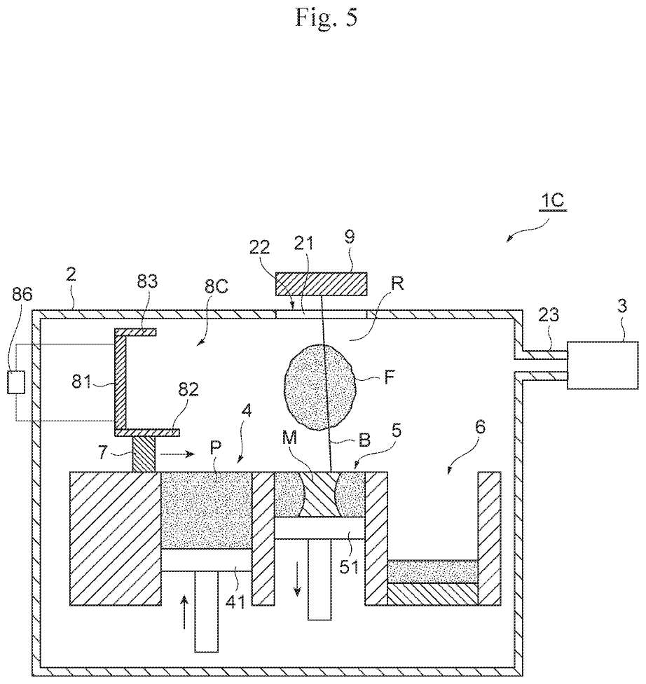

Next, a fourth embodiment of the additive manufacturing apparatus of the invention will be described with reference to FIG. 5.

FIG. 5 is a schematic cross-sectional view showing a schematic configuration of an additive manufacturing apparatus 1C according to the fourth embodiment of the invention. The additive manufacturing apparatus 1C of the present embodiment is different from the additive manufacturing apparatus 1 according to the first embodiment in a configuration of the fume capturing mechanism 8C. Since other components of the additive manufacturing apparatus 1C of the present embodiment are similar to those of the additive manufacturing apparatus 1 according to the first embodiment, the same components are denoted by the same reference numerals, and description thereof is omitted.

Similarly to the additive manufacturing apparatus 1 of the first embodiment, the additive manufacturing apparatus 1C of the present embodiment includes the fume capturing mechanism 8C that is provided to be movable in the space R defined between the beam source 9 and the stage 51, and that captures the fume F generated due to melting of the powder P. Therefore, similarly to the additive manufacturing apparatus 1 of the first embodiment, the additive manufacturing apparatus 1C of the present embodiment can effectively remove the fume F with the fume capturing mechanism 8C even in a vacuum state, and manufacture a high-quality molded object M.

Further, in the additive manufacturing apparatus 1C of the present embodiment, the fume capturing mechanism 8C includes a heating unit 86 that heats the capturing part 81. More specifically, in the example illustrated in FIG. 5, the heating unit 86 energizes the capturing part 81 and heats the capturing part 81 with heat generated by electric resistance of the capturing part 81. The heating unit 86, for example, heats the capturing part 81 to a temperature equal to or higher than a melting point of an additive manufacturing material. Specifically, when the additive manufacturing material is stainless steel, the heating unit 86 energizes the capturing part 81 to heat the capturing part 81 such that a surface temperature of the capturing part 81 is 600° C. or higher.

Accordingly, the fume F adhered to the capturing part 81 can be prevented from solidifying, and particles derived from the solidified fume F can be prevented from being re-suspended after being separated from the capturing part 81. In addition, the surface temperature of the capturing part 81 is set to 600° C. or higher by the heating unit 86 when the additive manufacturing material is stainless steel, so that the fume F, which is a high-temperature fine metal vapor, can be diffused and bonded to the capturing part 81 in a molten state. Therefore, the fume F can be more reliably captured by the capturing part 81.

### Fifth Embodiment

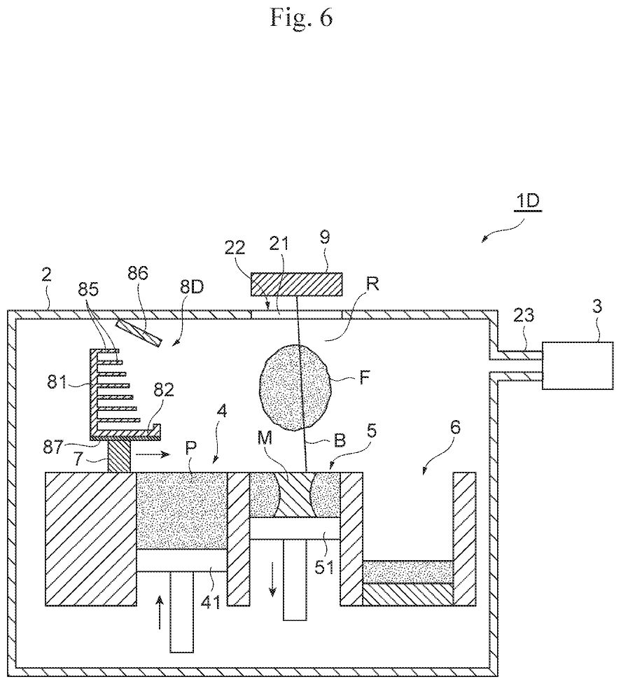

Next, a fifth embodiment of the additive manufacturing apparatus of the invention will be described with reference to FIG. 6.

FIG. 6 is a schematic cross-sectional view showing a schematic configuration of an additive manufacturing apparatus 1D according to the fifth embodiment of the invention. The additive manufacturing apparatus 1D of the present embodiment is different from the additive manufacturing apparatus 1 according to the first embodiment in a configuration of a fume capturing mechanism 8D. Since other components of the additive manufacturing apparatus 1D of the present embodiment are similar to those of the additive manufacturing apparatus 1 according to the first embodiment, the same components are denoted by the same reference numerals, and description thereof is omitted.

Similarly to the additive manufacturing apparatus 1 of the first embodiment, the additive manufacturing apparatus 1D of the present embodiment includes the fume capturing mechanism 8D that is provided to be movable in the space R defined between the beam source 9 and the stage 51, and that captures the fume F generated due to melting of the powder P. Therefore, similarly to the additive manufacturing apparatus 1 of the first embodiment, the additive manufacturing apparatus 1D of the present embodiment can effectively remove the fume F with the fume capturing mechanism 8D even in a vacuum state, and manufacture a high-quality molded object M.

In addition, in the additive manufacturing apparatus 1D of the present embodiment, similarly to the additive manufacturing apparatus 1A of the second embodiment, the fume capturing mechanism 8D includes a plurality of fins 85. In addition, the fume capturing mechanism 8D includes the heating unit 86 that heats the capturing unit 81, and a heat insulation plate 87 that prevents a decrease in a temperature of the capturing unit 81. The heating unit 86 is, for example, a lamp heater that heats by irradiating the capturing part 81 with an infrared ray. The heat insulation plate 87 is disposed between the capturing part 81 as well as the receiving part 82 and the recoater 7, and an appropriate heat insulation material that prevents heat of the capturing part 81 from transmitting to the recoater 7 can be used.

The additive manufacturing apparatus 1D of the present embodiment not only has effects similar to those of the additive manufacturing apparatus 1 of the first embodiment and the additive manufacturing apparatus 1A of the second embodiment, but also has effects similar to those of the additive manufacturing apparatus 1C of the fourth embodiment by including the heating unit 86. In addition, as compared with the additive manufacturing apparatus 1C of the fourth embodiment, since it is unnecessary to energize the moving capturing part 81, the configuration of the fume capturing mechanism 8D can be simplified.

### Sixth Embodiment

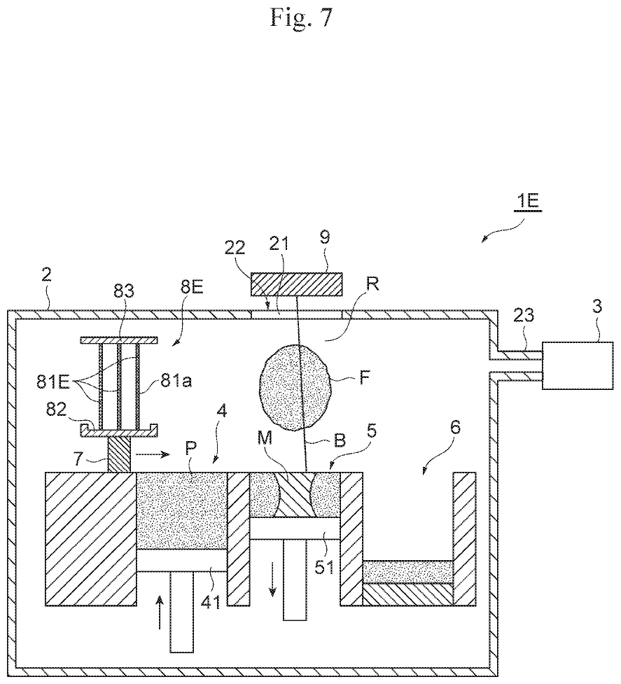

Next, a sixth embodiment of the additive manufacturing apparatus of the invention will be described with reference to FIG. 7.

FIG. 7 is a schematic cross-sectional view showing a schematic configuration of an additive manufacturing apparatus 1E according to the sixth embodiment of the invention. The additive manufacturing apparatus 1E of the present embodiment is different from the additive manufacturing apparatus 1 according to the first embodiment in a configuration of a fume capturing mechanism 8E. Since other components of the additive manufacturing apparatus 1E of the present embodiment are similar to those of the additive manufacturing apparatus 1 according to the first embodiment, the same components are denoted by the same reference numerals, and description thereof is omitted.

Similarly to the additive manufacturing apparatus 1 of the first embodiment, the additive manufacturing apparatus 1E of the present embodiment includes the fume capturing mechanism 8E that is provided to be movable in the space R defined between the beam source 9 and the stage 51, and that captures the fume F generated due to melting of the powder P. Therefore, similarly to the additive manufacturing apparatus 1 of the first embodiment, the additive manufacturing apparatus 1E of the present embodiment can effectively remove the fume F with the fume capturing mechanism 8E even in a vacuum state, and manufacture a high-quality molded object M.

In addition, in the additive manufacturing apparatus 1E of the present embodiment, a capturing part 81E of the fume capturing mechanism 8E is formed in a mesh shape having the capturing surface 81a intersecting a moving direction. In this way, by setting the catching part 81E in a mesh shape, the surface area of the capturing part 81E to which the fume F is adhered can be increased, and more of the fume F can be captured more reliably.

Further, the fume capturing mechanism 8E includes a plurality of capturing parts 81E arranged in the moving direction. Accordingly, the fume F that has passed through the capturing part 81E on a front side in the moving direction can be captured by the capturing part 81E on a rear side in the moving direction. In this case, mesh openings of the catching part 81E on the front side in the moving direction can be made larger than mesh openings of the capturing part 81E on the rear side in the moving direction. Accordingly, particles of the fume F having a relatively larger particle size can be captured by the capturing part 81E on the front side in the moving direction, and particles of the fume F having a relatively smaller particle size can be captured by the capturing part 81E on the rear side in the moving direction. It should be noted that the capturing part 81E is not limited to be in plurality, and may be a single one.

Although the embodiments of the invention have been described in detail with reference to the drawings, specific configurations are not limited to the embodiments, and design changes and the like within the scope not departing from the spirit of invention are included in the invention.

### REFERENCE SIGNS LIST

1 additive manufacturing apparatus
1A additive manufacturing apparatus
1B additive manufacturing apparatus
1C additive manufacturing apparatus
1D additive manufacturing apparatus
1E additive manufacturing apparatus
2 chamber
3 decompression unit
51 stage
6 collection part
7 recoater (moving mechanism)
8 fume capturing mechanism
8A fume capturing mechanism
8B fume capturing mechanism
8C fume capturing mechanism
8D fume capturing mechanism
8E fume capturing mechanism
81 capturing part
81E capturing part
81a capturing surface
82 receiving part
84 rotation mechanism
85 fin
85a inclined part
86 heating unit
9 beam source
B high energy beam
F fume
M molded object
P powder
R space

1. An additive manufacturing apparatus comprising a stage on which a powder of an additive manufacturing material is placed and a beam source configured to irradiate the powder with a high energy beam, and configured to manufacture a molded object by melting and bonding the powder with the high energy beam, the additive manufacturing apparatus further comprising:
a fume capturing mechanism provided to be movable in a space defined between the beam source and the stage, and configured to capture fume generated due to melting of the powder.

2. The additive manufacturing apparatus according to claim 1, wherein
the fume capturing mechanism includes a capturing part that extends in a direction intersecting a moving direction in the space to adhere the fume thereto.

3. The additive manufacturing apparatus according to claim 2, wherein
the fume capturing mechanism includes a receiving part that extends in a direction intersecting the extending direction of the capturing part and that receives particles derived from the fume separated from the capturing part.

4. The additive manufacturing apparatus according to claim 2, wherein
the capturing part is formed in a plate shape having a capturing surface that intersects the moving direction.

5. The additive manufacturing apparatus according to claim 4, wherein
the capturing part includes a plurality of fins that protrude toward a front side in the moving direction.

6. The additive manufacturing apparatus according to claim 5, wherein
the fins each include, at a tip end portion on a front side in the moving direction, an inclined part that extends obliquely rearward in the moving direction.

7. The additive manufacturing apparatus according to claim 2, wherein
the capturing part is formed in a mesh shape having a capturing surface that intersects the moving direction.

8. The additive manufacturing apparatus according to claim 7, wherein
the fume capturing mechanism includes a plurality of capturing parts arranged in the moving direction.

9. The additive manufacturing apparatus according to claim 2, further comprising:
a collection part configured to collect particles derived from the fume captured by the fume capturing mechanism, wherein
the fume capturing mechanism includes a rotation mechanism configured to rotate the capturing part toward the collection part.

10. The additive manufacturing apparatus according to claim 2, wherein
the fume capturing mechanism includes a heating unit configure to heat the capturing part.

11. The additive manufacturing apparatus according to claim 1, further comprising:
a moving mechanism configured to move the fume capturing mechanism in the moving direction.

12. The additive manufacturing apparatus according to claim 1, further comprising:
a chamber that accommodates the stage and the fume capturing mechanism; and
a decompression unit configured to decompress an inner portion of the chamber to a vacuum state in which a pressure thereof is lower than an atmospheric pressure.
